(19) United States
(12) Patent Application Publication
(10) Pub. No.: US 2005/0258126 A1
(43) Pub. Date: Nov. 24, 2005

(54) Double bottomed jar

(76) Inventor: Aniceto Canamasas Puigbo, Barcelona (ES)

Correspondence Address: PEARL COHEN ZEDEK, LLP, 10 ROCKEFELLER PLAZA, SUITE 1001, NEW YORK, NY, 10020, US

(21) Appl. No.: 11/133,294

(22) Filed: May 20, 2005

(30) Foreign Application Priority Data
May 21, 2004 (ES) ES200401233

(51) Int. Cl. B65D 41/04; A47J 41/02; B65D 23/00; B65D 21/00; B65D 1/04

(52) U.S. Cl. 215/12.1; 215/6; 215/10

(57) ABSTRACT

A double walled jar may include a first revolving external body inside of which a second revolving body is fitted which is greater in height than the first body. The bodies may be arranged so that there is an airtight chamber between them and may include an upper double walled lid, the first and second bodies being fixed by an upper and a lower fastener.

### PRIOR FILED APPLICATION

The present application claims priority from prior Spanish application ES200401233 filed on May 21, 2004, incorporated by reference herein in its entirety.

### BACKGROUND TO THE INVENTION

At the present time double walled jars are known for the marketing of cosmetic and similar products that are made up of an external body and an inner body between which there is an air chamber to provide insulation properties and with an upper double walled lid. Both the external body and equally the inner body are connected to each other by means of some upper and lower fasteners.

However, the main disadvantage of the previously described jars is that the inner body can have small movements or a small degree of play and due to the existence of the intermediate chamber the insulation does not occur over the entire surface of the inner body.

### SUMMARY OF THE INVENTION

The object of the present invention is an improved double walled jar comprising significant innovations and advantages compared to jars with similar characteristics and which have the same purpose.

A double walled jar may include a first revolving external body inside of which a second revolving body is fitted which is greater in height than the first body. The bodies may be arranged so that there is an airtight chamber between them and may include an upper double walled lid, the first and second bodies being fixed by an upper and a lower fastener.

The present invention has been developed for the purpose of providing an improved double walled jar that solves the previously stated disadvantages, moreover, providing other advantages that will be clear from the description which is attached below.

The improved double walled jar of the present invention is the type that includes a first revolving external body inside of which a second revolving body is fitted which is greater in height than the first body, both bodies being arranged so that there is an airtight chamber between them and an upper double walled lid, and the first and second bodies being fixed by an upper and a lower fastener, and is characterised by the fact that the upper fastener is formed by a protrusion arranged on the outer surface of the inner body, said protrusion having a wedge shaped protrusion towards the outside which fits into a slot in a complementary manner to the wedge arranged on the inner wall of the external body, and by the very fact that the internal fastener is made up of a rising and vertical tab located on the inner base of the external body that fits into a chamber located in external wall of the inner body base, said chamber being defined by an inwardly curved area of the external wall of the base and a downward extension of the side wall of said inner body.

Thanks to these characteristics, a jar is obtained, preferably made of an injected plastic material, which has insulating properties thanks to the presence of the air cavities defined between the inner and the outer bodies with optimum seal. It will be arranged in such a way that the upper fastener described performs a fastner function to the inner body and the inner fastener avoids any movement of same.

In accordance with another aspect of the invention, the double walled lid is made up of an inner part and an outer part, there being a thread on the inner side wall of the inside of the lid which screws onto a thread fitted to the external side wall of the body located above the upper fastener point of the outer body and the inner body.

Advantageously, the external body has a peripheral upper flat rim that lines up horizontally with the protrusion corresponding to the upper fastener. In this way, a wide variety of lids can be adapted independently of the thickness that they may have and without the need to carry out considerable geometrical alterations to the design of the lids.

Preferably, the jar of the invention has at least an airtight chamber between the side walls of the internal and external bodies and a second airtight chamber between the bases of the inner and outer bodies. In this way, the inner body has insulation from the outer body on all sides.

### BRIEF DESCRIPTION OF THE DRAWINGS

Other characteristics and advantages of the improved double walled jar object of the present invention will be come clear from the following description and in addition the drawings, which are not to be considered limiting, but are to provide examples, in which:

FIG. 1 shows an elevation section of the improved double walled jar of the present invention.

FIG. 2 shows a detailed sectioned elevation corresponding to the upper fastener between the inner and the outer bodies.

FIG. 3 shows a detailed sectioned elevation corresponding to the lower fastener between the inner and the outer bodies; and

FIG. 4 shows a sectioned elevation of a second embodiment of a double walled jar of the invention.

### DESCRIPTION OF A PREFERRED EMBODIMENT

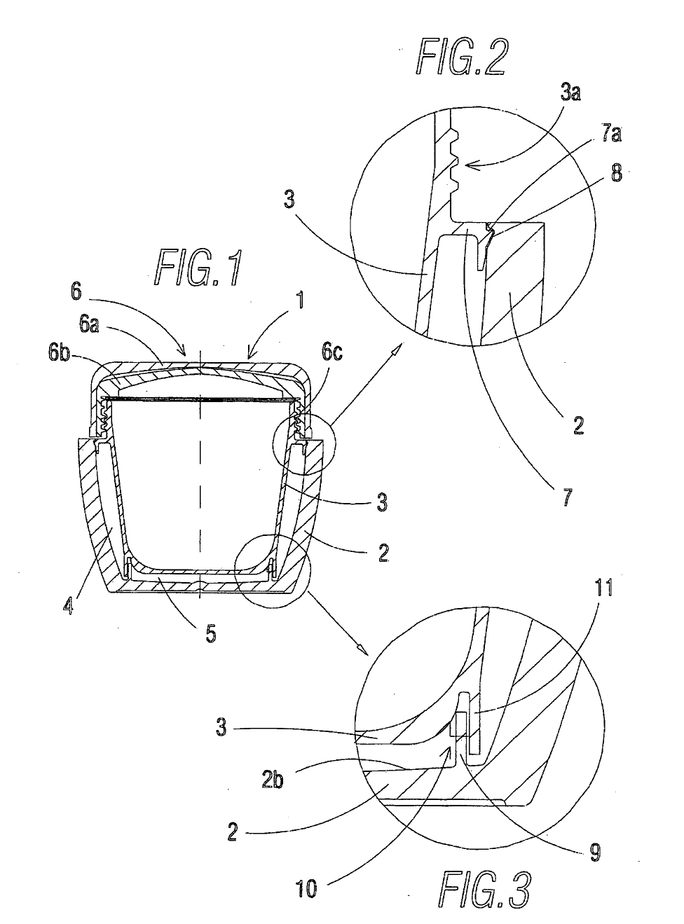

As and how shown in FIG. 1, the double walled jar (1) of the present invention is made up of a first revolving external body (2) inside of which a second revolving body (3) is fitted which is greater in height than the first body (2), both bodies (2) and (3) being arranged so that there is an airtight chamber (4) between the side walls of the external body (2) and the internal body (3) and a second airtight chamber (5) between the bases of the external body (2) and internal body (3). The jar (1) also has an upper double walled lid (6), the first (2) and the second (3) being fixed by an upper and a lower fastener.

Said upper fastener (see FIG. 2) is formed by a protrusion (7) arranged on the outer surface (3a) of the inner body (3), said protrusion (7) having a wedge shaped protuberance (7a) in an outward direction which fits into a groove (8) in a complementary manner to the wedge shaped protuberance (7a) arranged on the inner wall (2a) of the external body (2). On the other hand, the inner fastener is formed by a vertically rising tab (9) located on the inner surface (2b) of the external body base (2) that is fitted in a chamber (10) located in the external wall of the inner body base (3), said chamber (10) being defined by a curved inward section of the external base wall and a downward extension (11) of the side wall of said inner body (3), as can be appreciated in FIG. 3.

The double walled lid (6) is made from an external part (6a) and an inner part (6b), the internal side wall of the inner part (6b) of the lid (6) having a thread (6c) that screws with a thread (3a) arranged on the external side wall of the inner body (3) fitted above the upper fastener between the external body (2) and the inner body (3).

As can be seen in FIG. 2, the external body (2) has a peripheral flat upper rim (2c) that is horizontally lined up with a horizontal section of the protrusion (7) corresponding to the upper fastener.

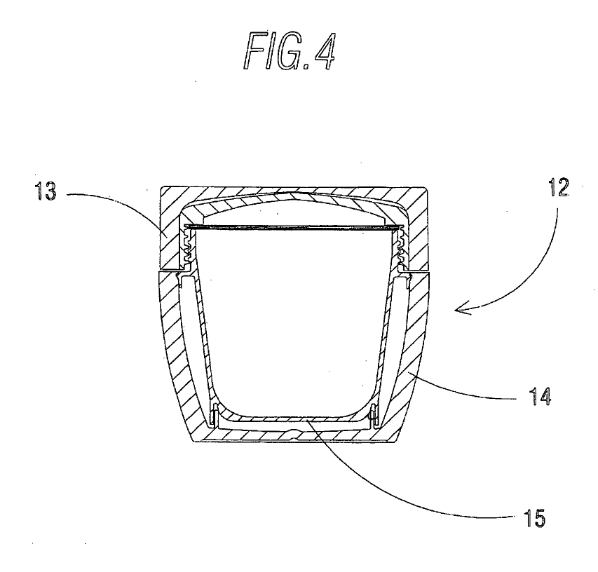

In FIG. 4, a second embodiment of the double walled jar (12) of the invention can be seen, in which the upper lid (13) has the same thickness as the external body (14), the upper and lower fasteners and also the attachment, of the upper lid (13) with the inner body (15) being identical as the jar (1) shown in FIG. 1.

The details, shapes, sizes and other accessorial elements, likewise the materials used for the construction of the improved double walled jar of the invention can suitably be substituted for others that are technically equivalent and do not deviate from the essentials of the invention or the scope defined by the claims which are included below.

1. A double walled jar comprising:
a first revolving external body inside of which a second revolving body is fitted which is greater in height than the first body, both bodies being arranged so that there is an airtight chamber between them and an upper double walled lid, and the first and second bodies being fixed by an upper and a lower fastener, wherein the upper fastener is formed by a protrusion arranged on the outer surface of the inner body, said protrusion having a wedge shaped protuberance towards the outside which fits into a slot in a complementary manner to the wedge arranged on the inner wall of the external body, and in that the internal fastener is made up of a rising and vertical tab located on the inner base of the external body that fits into a chamber located in external wall of the inner body base, said chamber being defined by an inwardly curved area of the external wall of the base and a downward extension of the side wall of said inner body.

2. A double walled jar according to the claim 1, wherein the double walled lid comprises an inner part and an outer part, there being a thread on the inner side wall of the inside of the lid which screws onto a thread fitted to the external side wall of the inner body located above the upper faster point of the outer body and the inner body.

3. A double walled jar according to claim 1, wherein the external body comprises a peripheral upper flat rim that lines up horizontally with the protrusion corresponding to the upper fastener

4. A double walled jar according to claim 1, comprising an airtight chamber between the side walls of the internal and external bodies and a second airtight chamber between the bases of the inner and outer bodies.
